(19) United States
(12) Patent Application Publication
(10) Pub. No.: US 2024/0322132 A1
(43) Pub. Date: Sep. 26, 2024

(54) SULFURED-CARBON NANOMATERIAL ELECTRODES FOR ENERGY STORAGE AND METHODS FOR TO PRODUCE THE SAME

(71) Applicant: National University of Singapore, Singapore (SG)

(72) Inventors: Sergio Graniero Echeverrigaray, Singapore (SG); Vivek Nair, Singapore (SG); Antonio Helio Castro Neto, Singapore (SG)

(73) Assignee: National University of Singapore, Singapore (SG)

(21) Appl. No.: 18/579,181

(22) PCT Filed: Jul. 8, 2022
(86) PCT No.: PCT/SG2022/050475

§ 371 Date: Jan. 12, 2024

(30) Foreign Application Priority Data
Jul. 12, 2021 (SG) 10202107631T

(51) Int. Cl. H01M 4/36; H01M 4/02; H01M 4/58; H01M 4/583; H01M 10/05

(52) U.S. Cl. CPC H01M 4/366; H01M 4/5815; H01M 4/583; H01M 10/05; H01M 2004/027; H01M 2004/028

(57) ABSTRACT

Disclosed herein is a nanoparticulate material, that includes a carbon nanomaterial having a first surface, a second surface and one or more edges; and sulfur on the first and second surfaces and the one or more edges of the carbon nanomaterial, where the sulfur forms from 50 wt. % to 99 wt. % of the composition when measured using one or both of CHNS elemental analysis and thermogravimetric analysis. Also disclosed herein are batteries using said material.

### FIELD OF INVENTION

The current invention relates to the field of sulfur batteries and particularly to the formation and use of a sulfur-decorated carbon nanomaterial with enhanced properties. The invention also relates to the use of said material as the active material in cathodes and anodes of sulfur-based batteries and methods of forming said material.

### BACKGROUND

The listing or discussion of a prior-published document in this specification should not necessarily be taken as an acknowledgement that the document is part of the state of the art or is common general knowledge.

Lithium-ion batteries are important rechargeable energy storage devices, which are commonly found in many electronic devices. Given the high ownership and usage of portable devices such as smartphones and laptops, the demand for rechargeable batteries has grown tremendously. This growth has accelerated due to the emergence of hybrid and all-battery electric vehicles, which demand advanced batteries with higher energy densities and lower costs. As will be appreciated, energy densities and cost are the most important factors that influence whether a new battery technology can enter the markets associated with portable electronic devices, electric-grid energy storage, and electric transportation.

An example of a promising energy storage devices are the sulfur battery. Among the sulfur batteries, the lithium-sulfur (Li—S) battery is the most notable, which uses low-cost cathode materials (compared, for example, to nickel-manganese-cobalt, NMC) and provides high discharge capacity. In fact, Li—S batteries have a higher theoretical energy density (S:Li metal, 3,517.5 W h kg⁻¹ of S) than conventional lithium-ion batteries (NMC811:Graphite, 730 W h kg⁻¹ of NMC), which makes this technology a potential solution to the growing demand for more portable energy. However, Li—S batteries are yet to achieve the energy densities that the technology is capable of due to several technical challenges such as low sulfur loading per area in the cell and a low sulfur fraction in the cathode material. Another significant drawback with cells containing cathodes having sulfur materials is the dissolution and diffusion of polysulfides from the cathode to the rest of the cell, which often leads to problems such as high self-discharge rates and loss of capacity.

Given the above, there remains a need to develop new electrode materials to solve one or more of the above-mentioned problems associated with sulfur battery technology. More importantly, such materials need to provide high energy density, current rate, and cycling stability. In addition, the preparation of these materials has to be capable of being scaled up.

### SUMMARY OF INVENTION

Aspects and embodiments of the invention will now be described by reference to the following numbered clauses.

1. A nanoparticulate material, comprising:
a carbon nanomaterial having a plurality of active sites; and
sulfur attached to the plurality of active sites of the carbon nanomaterial,
wherein
the sulfur forms from 50 wt. % to 99 wt. % of the composition when measured using one or both of CHNS elemental analysis and thermogravimetric analysis.

2. The nanoparticulate material according to Clause 1, wherein the carbon nanomaterial is selected from one or more of the group consisting of carbon nanotubes, carbon nanofibers, fullerenes, graphenes, graphene oxides, nanographites, carbon blacks, acetylene blacks, thermal blacks, mesoporous carbons, carbon quantum dots, and graphene quantum dots.

3. The nanoparticulate material according to Clause 2, wherein the carbon nanomaterial is a graphene and/or a carbon black

4. The nanoparticulate material according to Clause 3, wherein the graphene is in the form of graphene nanoplatelets and the carbon black is in the form of Ketjen black.

5. The nanoparticulate material according to any one of the preceding clauses, wherein the nanoparticulate material may further comprise halogen atoms bonded to the carbon nanomaterial.

6. The nanoparticulate material according to any one of the preceding clauses, wherein the nanoparticulate material may further comprise halogen atoms attached to a first portion of the plurality of active sites.

7. The nanoparticulate material according to Clause 5 or Clause 6, wherein the halogen atoms are selected from one or more of the group consisting of F, Cl, Br, and I, optionally wherein the halogen atoms are selected from one or more of the group consisting of F, Cl and Br (e.g., the halogen atoms are F).

8. The nanoparticulate material according to any one of the preceding clauses, wherein the sulfur forms from 50 to 97 wt. % of the composition when measured using one or both of CHNS elemental analysis or thermogravimetric analysis.

9. The nanoparticulate material according to Clause 8, wherein the sulfur content is from 70 to 96 wt % of the composition when measured using one or both of CHNS elemental analysis or thermogravimetric analysis.

10. The nanoparticulate material according to Clause 9, wherein the sulfur content is from 85 to 95 wt %, such as from 88 to 94 wt % of the composition when measured using one or both of CHNS elemental analysis or thermogravimetric analysis.

11. The nanoparticulate material according to any one of the preceding clauses, wherein at least part of the sulfur is covalently bonded to a second portion of the plurality of active sites of the carbon nanomaterial.

12. The nanoparticulate material according to any one of the preceding clauses, wherein the plurality of active sites are one or more active sites selected from the group consisting of a surface, an edge, a defect (e.g., a pore), and an interlayer.

13. The nanoparticulate material according to any one of the preceding clauses, wherein a first portion of the sulfur is electrostatically bonded (ionicallyNan der Waals) to the carbon nanomaterial and a second portion of the sulfur is covalentiy bonded.

14. A sulfur battery comprising:
a cathode comprising a nanoparticulate material as described in any one of Clauses 1 to 13;
an anode;
an electrolyte; and
a separator, optionally wherein the anode comprises an active material that has an electrochemical redox potential below 1.4 V versus U.

15. The sulfur battery according to Clause 14, wherein the anode may be selected from one or more of the group consisting of Si, Li, Na, Mg, Al, Ca, graphite.

16. A sulfur battery comprising:
an anode comprising a nanoparticulate material as described in any one of Clauses 1 to 13;
a cathode;
an electrolyte; and
a separator, optionally wherein the cathode comprises an active material that has an electrochemical redox potential above 2.6 V versus U.

17. The sulfur battery according to Clause 16, wherein the cathode is selected from LiMn₂O₄, LiNiMn₂O₄, LiNiMnCoO₂, LiCoO₂, LiFePO₄.

18. The sulfur battery according to any one of Clauses 14 to 17, wherein a specific energy density of the sulfur battery is from 600 Wh to 3,600 Wh per kilogram of sulphur, with a total sulfur mass loading of from 1 to 30 mg cm⁻² (e.g. from 1 to 20 mg cm⁻²).

19. The sulfur battery according to Clause 18, wherein the specific energy density of the sulfur battery is from 2,210 Wh to 2,883 Wh per kilogram of sulphur at a current rate of 0.05 C with a sulfur mass loading of from 3.5 to 7 mg over an electrode area of 2 cm², optionally wherein the specific energy density of the sulfur battery is 2,257 Wh per kilogram of sulphur with a sulfur mass loading of 3.5 mg.

20. A method of making a nanoparticulate material according to any one of Clauses 1 to 13, wherein the method comprises the steps of:
(a) providing carbon nanomaterials and dispersing them into a solution comprising water, a non-ionic surfactant and a metal thiosulfate to form a precursor solution; and
(b) adding an aqueous sulfuric acid solution to the precursor solution and allowing reaction for a period of time to form the nanoparticulate material.

21. The method according to Clause 20, wherein the aqueous sulfuric acid solution has a concentration of from 0.1 to 1.0M, such as 0.3M.

22. The method according to Clause 20 or Clause 21, wherein the aqueous sulfuric acid solution is provided in a volume to volume ratio compared to the precursor solution of from 1:1 to 1:10, such as from 1:2 to 1:5, such as from 3:4 to 3:5.

23. The method according to any one of Clauses 20 to 22, wherein the carbon nanomaterials are non-halogenated or halogenated, optionally wherein the halogenation is with one or more of F, Br, Cl or I, such as one or more of F, Br or Cl, such as F.

24. The method according to Clause 23, wherein the halogenated carbon nanomaterials are formed by the steps of:
(a) sonicating a dispersion of carbon nanomaterials in water to form a carbon nanomaterial suspension; and
(b) reacting the dispersed carbon nanomaterials suspension with a solution of a hydrophilic acid to form halogenated carbon nanomaterials.

### BRIEF DESCRIPTION OF DRAWINGS

FIG. 1 Depicts the TGA analysis of S—F-GNP, F-GNP and untreated GNP.

FIG. 2 Depicts the TEM images of: (a) as-received GNP (with scale bar of 200 nm); (b) F-GNP, (c) S—F-GNP, and (d) S-GNP (with scale bar of 100 nm) of the current invention.

FIG. 3 Depicts the XPS spectra and deconvolution peaks of: (a) F-GNP sample showing halogenation on the C1s and F1s regions; and (b) S—F-GNP sample showing sulfurization on the S2p and C1s regions. Details and data at Table 4 and 5.

FIG. 4 Depicts the specific discharge capacity at different current rates (cathode with sulphur loading of 7 mg).

FIG. 5 Depicts the specific discharge capacity and Coulombic efficiency for the as-synthesised materials over 85 cycles at 0.3 C rate (cathode with sulphur loading of 7 mg).

FIG. 6 Depicts the specific discharge capacity and Coulombic efficiency for S—F-GNP and S-GNP over 85 cycles at 0.3 C rate (cathode with sulphur loading of 7 and 3.5 mg).

FIG. 7 Depicts the specific discharge capacity and Coulombic efficiency for S—F-GNP and S-GNP over 200 cycles at 0.3 C rate (cathode with sulphur loading of 3.5 mg).

FIG. 8 Depicts the specific discharge capacity for the as-synthesised S-GNP over 50 cycles at 0.05 C rate (cathode with sulphur loading of 3.5 mg).

### DESCRIPTION

Surprisingly, it has been found that a sulfur-decorated carbon nanomaterial can address some or all of the problems identified above. Thus, in a first aspect of the invention there is provided a nanoparticulate material, comprising:
a carbon nanomaterial having a plurality of active sites; and
sulfur attached to the plurality of active sites of the carbon nanomaterial,
wherein
the sulfur forms from 50 wt % to 99 wt. % of the composition when measured using one or both of CHNS elemental analysis and thermogravimetric analysis.

When used herein, the term “carbon nanomaterial” may refer to any suitable material that has suitable size range. For example, in certain embodiments of the invention that may be disclosed herein, the carbon nanomaterial may have an average hydrodynamic diameter of from 1 to 1,000 nm, such as from 100 to 400 nm, such as from 1 to 100 nm. In more particular embodiments of the invention hat may be mentioned herein, the term “carbon nanomaterial” may refer to a “carbon nano-object” as defined under the standard “ISO/TS 80004-3:2020(en) Nanotechnologies—Vocabulary—Part 3: Carbon nano-objects”, which is hereby incorporated herein by reference.

Examples of suitable carbon nanomaterials include, but are not limited to carbon nanotubes, carbon nanofibers, fullerenes, graphenes, graphene oxides, nanographites, carbon blacks, acetylene blacks, thermal blacks, mesoporous carbons, carbon quantum dots, graphene quantum dots and combinations thereof. In particular embodiments that may be mentioned herein, the carbon nanomaterial may be a graphene and/or a carbon black. These materials may be as defined in the standard “ISO/TS 80004-3:2020(en) Nanotechnologies—Vocabulary—Part 3: Carbon nano-objects”. In particular examples that may be mentioned herein, the graphene may be in the form of graphene nanoplatelets and the carbon black may be in the form of Ketjen black. Graphene nanoplatelets as used herein may take the definition of the standard: ISO/TS 80004-13:2017. Suitable graphene nanoplatelets may be commercially available.

In certain embodiments of the invention that may be mentioned herein, the nanoparticulate material may further comprise halogen atoms attached to the carbon nanomaterial. The halogen atoms may be attached to active-sites in the carbon nanomaterial. Examples of active sites in the carbon nanomaterial may include, but are not limited to surfaces, edges, defects (e.g. pores), and interlayers.

Without wishing to be bound by theory, it is believed that the sulfur nucleation in the halogenated-graphene can be improved by the presence of halogen atoms bonded mainly, but not limited to, to carbon active-sites on the carbon nanomaterials' structure. It may occur mainly, but not only, through a nucleophilic substitution reaction, also known as the ion-exchange reaction. In the final material, a carbon nanomaterials' structure doped with sulfur is obtained. As such, the majority of the halogen atoms in the halogenated carbon nanomaterial may be replaced by sulfur. Nevertheless, there may remain traces (e.g. less than 1% in atomic concentration) of halogen atoms within the final products. As such, a portion of the active sites in the carbon nanomaterial may remain occupied by halogen atoms in the products mentioned herein.

It is notable that the sulphur content detected on all of the pre-halogenated graphene starting materials used herein ends up higher than the corresponding non-halogenated graphene starting material by about ˜1.5 to 5.3 wt %.

Any suitable halogen may be used herein. For example, the halogen atoms may be selected from one or more of the group consisting of F, Cl, Br, and I, optionally wherein the halogen atoms may be selected from one or more of the group consisting of F, Cl and Br (e.g. the halogen atoms may be F).

In the nanoparticulate materials disclosed herein, any suitable amount of sulfur may be present. For example, the sulfur may form from 50 to 97 wt. % of the composition when measured using one or both of CHNS elemental analysis or thermogravimetric analysis. In particular embodiments of the invention that may be mentioned herein, the sulfur content may be from 70 to 96 wt %, such as from 85 to 95 wt %, such as from 88 to 94 wt % of the composition when measured using one or both of CHNS elemental analysis or thermogravimetric analysis.

In embodiments of the invention that may be mentioned herein at least part of the sulfur may be covalently bonded to the surface of the carbon nanomaterial. That is, at least part of the sulfur may be covalently bonded to the active sites of the carbon nanomaterial.

As will be appreciated, the carbon nanomaterials disclosed herein may have one or more surfaces, one or more edges, one or more defects (e.g., pores) and one or more interlayers and at least part of the sulfur may be covalently bonded to said one or more edges, one or more defects and one or more interlayers in certain embodiments of the invention that may be mentioned herein. As will be appreciated, the one or more surfaces, the one or more edges, the one or more defects and one or more interlayers may all be collectively defined as active sites (i.e. a site to which a sulfur and/or halogen atom may be attached (e.g., covalently bonded)). It will be further appreciated that which of these active sites are present will depend on the form of carbon nanomaterial being utilised.

As will be appreciated, part of the sulfur may be electrostatically bonded to the carbon nanomaterial, while a further part of the sulfur may be covalently bonded. Thus, in embodiments of the invention that may be mentioned herein, there may be provided a first portion of the sulfur that is electrostatically bonded (ionicallyNan der Waals) to the carbon nanomaterial and a second portion of the sulfur that is covalentiy bonded to said nanomaterial. Any suitable ratio of the first portion to the second portion is envisaged.

In particular examples that may be mentioned herein, when the carbon nanomaterial is in the form of graphene nanoplatelets, the nanoparticulate material may have a BET surface area of from 1 m² g⁻¹ to 10 m² g⁻¹, such as from 2 m² g⁻¹ to 8 m² g⁻¹, such as from 3 m² g⁻¹ to 6 m² g⁻¹, such as 4.7 m² g⁻¹. In additional or alternative embodiments, the nanoparticulate material may have a BET surface area of from 1 m² g⁻¹ to 100 m² g⁻¹, such as from 2 m² g⁻¹ to 50 m² g⁻¹, such as from 3 m² g⁻¹ to 10 m² g⁻¹, such as 4.7 m² g⁻¹. It is noted that the final BET surface area obtained may change significantly depending on the starting material and so these values should not be considered in any way limiting on the range of BET surface areas that can be obtained using the methods disclosed herein.

The materials disclosed herein have been surprisingly found to act as superior active materials in sulfur battery systems. This may be as the cathode active material or as the anode active material.

The sulfur batteries disclosed herein, may display any suitable specific energy density. In particular the sulfur batteries disclosed herein may have a specific energy density of from 600 Wh to 3,600 Wh per kilogram of sulphur, with a sulfur mass loading of from 1 to 30 mg cm⁻² (e.g., from 1 to 20 mg cm⁻²). For example, the sulfur batteries disclosed herein may have a specific energy density of from 2,000 Wh to 2,900 Wh per kilogram of sulphur, with a sulfur mass loading of from 1 to 20 mg cm⁻².

The sulfur batteries disclosed herein may have superior specific energy densities. For example, the specific energy density of a sulfur battery disclosed herein may be from 2,210 Wh to 2,883 Wh per kilogram of sulfur at a current rate of 0.05 C with a sulfur mass loading of from 3.5 to 7 mg for an electrode area of 2 cm², optionally wherein the specific energy density of the sulfur battery may be 2,257 Wh per kilogram of sulphur with a sulfur mass loading of 3.5 mg.

### Nanoparticulate Material as Cathode

Thus in a further aspect of the invention, there is provided a sulfur battery comprising:
a cathode comprising a nanoparticulate material as described hereinbefore;
an anode;
an electrolyte; and
a separator.

In this aspect of the invention, the nanoparticulate material disclosed herein functions as at least part of the cathode active material. Any compatible active material may be used in the anode. For example, the anode may comprise an active material that has an electrochemical redox potential below 1.4 V versus U. Examples of sulfur batteries where the nanoparticulate material described herein is used as at least part of the cathode active material may include, but is not limited to, batteries using U, Na, Mg, Al, Ca, graphite and their alloys.

Cathodes of the current invention may comprise a current collector with a layer of the active material thereon, which layer also comprises at least one of a binder and a conductive material (when required) in addition to the active material.

The current collector may be any suitable electrical conductor for a cathode, containing for example, aluminium, stainless steel, nickel, niobium, carbon, and/or the like. It is also possible for a single cathode to contain more than one of the above nanoparticulate materials in combination. Any suitable weight ratio may be used when the active materials above are used in combination. For example, the weight ratio for two active materials in a single cathode may range from 1:100 to 100:1, such as from 1:50 to 50:1, for example 1:1. In additional or alternative embodiments, the battery may comprise more than one cathode. When the battery contains more than one cathode (e.g. from two to 10, such as from 2 to 5 cathodes) the active materials may be chosen from those above and each cathode may independently contain only one cathode active material or a combination of two or more active materials as discussed above.

When the cathode is formed using the nanoparticulate material as described herein as a cathode active material, other active materials that have their electrochemical redox potential between 3 V and 0.8 V versus Li may be used in combination with the nanoparticulate material. The other active materials include, but are not limited to, MnO₂, TiNb₂O₇, Ti₄O₇, Li₄TiO₁₂, V₂O₅, FeS₂, MoS₂, NiS₃, Nb₂O₅, NbS₂, and LiNbO₃.

The binder improves binding properties of the active material particles with one another and the current collector. The binder may be a non-aqueous binder, an aqueous binder, or a combination thereof. The binder is not particularly limited as long as it binds the active material and the conductive material on a current collector, and simultaneously (or concurrently) has no electrochemical degradation.

Non-aqueous binders that may be mentioned herein include, but are not limited to, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

Aqueous binders can be either natural, modified, or synthesized materials that may be mentioned herein include, but are not limited to, a rubber-based, a polymer resin, or a polysaccharide binder. Rubber-based binders may be selected from styrene-butadiene rubber, acrylated styrene-butadiene rubber (SBR), acrylonitrile-butadiene rubber, acrylic rubber, butyl rubber, fluorine rubber, natural rubber, and a combination thereof. Polymer resin binders may be selected from ethylenepropylene copolymer, epichlorohydrin, polyphosphazene, polyacrylonitrile, polystyrene, ethylenepropylenediene copolymer, polyvinylpyridine, chlorosulfonated polyethylene, a polyester resin, an acrylic resin, a phenolic resin, an epoxy resin, polyvinyl alcohol and a combination thereof.

Polysaccharide binders may be selected from carboxylmethyl cellulose, hydroxypropylmethyl cellulose, methyl cellulose, or their alkali metal salts thereof, gum tragacanth, gum arabic, gellan gum, xanthan gum, guar gum, karaya gum, chitosan, sodium alginate, cyclodextrin, starches, and a combination thereof. The alkali metal may be Na, K, or Li. Such a cellulose-based compound may be included in an amount of about 0.1 parts by weight to about 20 parts by weight based on 100 parts by weight of the active material. Preferable binders that may be mentioned herein are the sodium salt of carboxylmethyl cellulose, gum Arabic, polyvinyl alcohol, or a combination thereof.

The electrical conductive material improves the electrical conductivity of an electrode. Any electrically conductive material may be used as a conductive material, unless it causes a chemical change, and examples thereof may be natural graphite, artificial graphite, carbon black, acetylene black, ketjen black, carbon fiber, graphene and/or like carbon-based material; copper, nickel, aluminum, silver, niobium, and/or like metal powder or metal fiber and/or like metal-based material; polyphenylene derivative and/or like conductive polymer; and/or a mixture thereof.

Cathodes using the nanoparticulate material of the current invention may be manufactured using the following method. First, the active material, the conductive material, and the binder are mixed in a desirable ratio (e.g., active material(s):conductive material(s):binder(s) ratio of from 50:40:10 to 96:2:2, specific ratios that may be mentioned include, but are not limited to 70:20:10 and 80:10:10) and dispersed in an aqueous solution and/or an organic solvent (such as N-methyl-2-pyrrolidone) to form a slurry. Additionally or alternatively, the amount of active substance in the cathodes may be from 50 to 96 wt %, the amount of conductive material (e.g. conductive carbon black) may be from 2 to 40 wt % and the amount of binder may be from 2 to 10 wt %. Subsequently, the slurry is coated on a current collector and then dried to form an active material layer. Herein, the coating method is not particularly limited, and may be, for example, a tape casting coating method (e.g. knife coating), a gravure coating method, and/or the like. Then, the active material layer is compressed utilizing a compressor (such as a roll press) to a desirable thickness to manufacture an electrode. A thickness of the active material layer is not particularly limited, and may be any suitable thickness that is applicable to an electrode for sulfur batteries. The active material loading may be from 1 to 30 mg cm⁻², for example the active material loading may be from 1 to 20 mg cm⁻², such as from 1 to 6 mg cm⁻².

The anode active material for the cathode described above may include an alkali or alkaline earth metal, metal oxide, metal-sulfide, their alloy or their composite with a carbon-based material, a silicon-based material, a tin-based material, an antimony-based material, a lead-based material, and/or the like, which may be utilized singularly or as a mixture of two or more. The lithium metal oxide may be, for example, a titanium oxide compound such as Li₄Ti₅O₁₂, Li₂Ti₆O₁₃ or Li₂TiO₇. The sodium metal oxide may be, for example, a titanium oxide compound such as Na₂Ti₃O₇ or Na₂Ti₆O₁₃. Other metal oxides that may be mentioned herein as suitable include, but are not limited to, TiO₂, Fe₂O₃, Nb₂O₅, MoO₃. The anode may be formed in similar manner to that described herein before. The anode may further include a binder and a conductive additive.

The sulfur battery also includes a separator. The separator is not particularly limited, and may be any suitable separator utilized for a sulfur battery. For example, a non-electrical conductive porous layer or a nonwoven fabric may be utilized alone or as a mixture (e.g., in a laminated structure).

A material of the separator may comprise, for example, a glass fibre, nonwoven fabric, or a polyolefin-based resin, a polyester-based resin, polyvinylidene difluoride (PVDF), a vinylidene difluoride-hexafluoropropylene copolymer, a vinylidene difluoride-perfluorovinylether copolymer, a vinylidene difluoride-tetrafluoroethylene copolymer, a vinylidene difluoride-trifluoroethylene copolymer, a vinylidene difluoride-fluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoropropylene copolymer, a vinylidene difluoride-tetrafluoroethylene-hexafluoropropylene copolymer, a vinylidene difluoride-ethylene-tetrafluoroethylene copolymer, and/or the like. The polyolefin-based resin may be polyethylene, polypropylene, and/or the like; and the polyester-based resin may be polyethylene terephthalate, polybutylene terephthalate, and/or the like.

The separator may include a coating layer including an inorganic or organic filler may be formed on at least one side of the substrate. The inorganic filler may include Al₂O₃, Mg(OH)₂, SiO₂, and/or the like. The organic filler may include carbon-based materials like carbon nanotubes, carbon nanofibers, graphenes, graphene oxides, nanographites, carbon blacks, mesoporous carbons, and/or the like. The coating layer may inhibit direct contact between the electrodes and the separator, inhibit oxidation and decomposition of an electrolyte on the surface of the electrodes during storage at a high temperature, and suppress the generation of gas that is a decomposed product of the electrolyte. A suitable separator that may be mentioned herein is a trilayer polypropylene separator.

It will be appreciated that any of the above separators may be used in the aspects and embodiments of the current invention, provided that they are a technically sensible choice.

Any suitable electrolyte may be used in sulfur battery. Examples of suitable electrolyte materials include, but are not limited to UTFSI (Lithium Bis(trifluoromethanesulfonyl) imide) in Dimethoxyethane and Dioxolane. The electrolyte can contain any combination of soluble alkali or alkaline earth metal ion salts in various organic solvents or mixture of solvents, or in polymer-based quasi-solid and solid electrolytes, or in ionic liquids. The molarity of solution can vary from 0.1-15.0M. Salts may be taken from LITFSI (Lithium Bis(trifluoromethanesulfonyl) imide), LiFSI (Lithium Bis(fluoro methane sulfonyl)imide), LiOTf (Lithium trifluoro methanesulfonate), UPFe (Lithium hexafluorophosphate), NaTFSI (Sodium Bis(trifluoromethanesulfonyl) imide), NaFSI (Sodium Bis(fluoro methane sulfonyl)imide), NaOTf (Sodium trifluoro methanesulfonate), NaPF₆ (Sodium hexafluorophosphate). Solvents may be selected from one or more of diglyme, monoglyme, tetraglyme, dimethyl sulfoxide, dioxolane, N-methyl-2-pyrrolidone, water, sulfones, and ionic liquids.

The electrolyte may further include various suitable additives such as a negative electrode SEI (solid electrolyte interface) forming agent or positive electrode CEI (cathode electrolyte interface) forming agent, a surfactant, and/or the like. Such additives may be, for example, succinic anhydride, lithium bis(oxalato)borate, sodium bis(oxalato)borate, lithium tetrafluoroborate, a dinitrile compound, propane sultone, butane sultone, propene sultone, 3-sulfolene, a fluorinated allylether, a fluorinated acrylate, carbonates such as vinylene carbonate, vinyl ethylene carbonate and fluoroethylene carbonate and/or the like. The concentration of the additives may be any suitable one that is utilized in a general sulfur battery. Additives that may be included in the electrolyte are for example lithium nitrate, lithium niobate, fluoroethylene carbonate (FEC), vinylene carbonate (VC), vinyl ethylene carbonate (VEC), biphenyl, adiponitrile, and combinations thereof. The above additives may be present in any suitable weight ratio.

In a sulfur battery, the separator may be disposed between the positive electrode and the negative electrode to manufacture an cell structure, and the cell structure is processed to have a desired shape, for example, a cylinder, a prism, a laminate shape, a button shape, and/or the like, and inserted into a container having the same shape. Then, the electrolyte is injected into the container and impregnated in the pores of the separator and electrodes, thereby resulting in a rechargeable sulfur battery.

### Nanoparticulate Material as Anode

Thus yet a further aspect of the invention, there is provided a sulfur battery comprising:
a cathode;
an anode comprising a nanoparticulate material as described hereinbefore;
an electrolyte; and
a separator. In this aspect of the invention, the nanoparticulate material disclosed herein functions as at least part of the anode active material. Any compatible active material may be used in the cathode. For example, the cathode may comprise an active material that has an electrochemical redox potential above 2.6 V versus U. Examples of sulfur batteries where the nanoparticulate material described herein is used as at least part of the cathode active material may include, but is not limited to, LiMn₂O₄, LiNiMn₂O₄, LiNiMnCoO₂, LiCoO₂, LiFePO₄ and their combinations.

When the anode is formed using the nanoparticulate material as described herein as a negative active material, other active materials that have their electrochemical redox potential between 2.2 V and 0 V versus U may be used in combination with the nanoparticulate material. The other active materials include, but are not limited to, graphite-based material, a silicon-based material, TiO₂, TiNb₂O₇, Li₄TiO₂, FeS₂, MoS₂, NbS₂, and LiNbO₃.

It will be appreciated that the above negative active materials may be used individually. That is, an anode may only contain one of the above negative active materials. However, it is also possible for a single anode to contain more than one of the above materials in combination. Any suitable weight ratio may be used when the active materials above are used in combination. For example, the weight ratio for two active materials in a single anode may range from 1:100 to 100:1, such as from 1:50 to 50:1, for example 1:1. In additional or alternative embodiments, the battery may comprise more than one anode. When the battery contains more than one anode (e.g. from two to 10, such as from 2 to 5 anodes) the active materials may be chosen from those above and each anode may independently contain only one anode active material or a combination of two or more active materials as discussed above.

The binder and conductive material (if any) are not particularly limited, and may be the same binder and conductive material as that of the cathode. A weight ratio of the negative active material, binder, and conductive material are not particularly limited.

The anode may be manufactured as follows. The negative active material(s), conductive additive (if required) and the binder are mixed in a desired ratio and the mixture is dispersed in an appropriate solvent (such as water and/or the like) to prepare a slurry. Then, the slurry is applied on a current collector and dried to form a negative active material layer. Then, the negative active material layer is compressed to have a desired thickness by utilizing a compressor, thereby manufacturing the anode. Herein, the negative active material layer has no particularly limited thickness, but may have any suitable thickness that a negative active material layer for a sulfur battery may have.

The separator, cell configuration, cell structure, and electrolyte may be the same separator, cell configuration, cell structure, and electrolyte as that of the cathode as described above using the nanoparticulate material disclosed herein.

Hereinafter, embodiments of the invention are illustrated in more detail with reference to the following examples. However, the present disclosure is not limited thereto. Furthermore, what is not described in this disclosure may be sufficiently understood by those who have knowledge in this field and will not be illustrated herein.

In a further aspect of the invention, there is provided a method of making the nanoparticulate material disclosed herein, which method comprises the steps of:
(a) providing carbon nanomaterials and dispersing them into a solution comprising water, a non-ionic surfactant and a metal thiosulfate to form a precursor solution; and
(b) adding an aqueous sulfuric acid solution to the precursor solution and allowing reaction for a period of time to form the nanoparticulate material.

The aqueous sulfuric acid solution may have any suitable concentration in the method disclosed herein. For example, the aqueous sulfuric acid solution may have a concentration of from 0.1 to 1.0M, such as 0.3M. Any suitable amount of the aqueous sulfuric acid solution may be used in comparison to the precursor solution. For example, the aqueous sulfuric acid solution may be provided in a volume to volume ratio compared to the precursor solution of from 1:1 to 1:10, such as from 3:4 to 1:5, such as 3:5. As will be appreciated, other suitable ratios may also exist and are not excluded from the scope of the current invention.

The carbon nanomaterials may be non-halogenated or they may be halogenated. As noted above, halogenated carbon nanomaterials may enable a greater quantity of sulfur to be attached to the carbon nanomaterials than to the equivalent carbon nanomaterial that is non-halogenated. Halogenated carbon nanomaterials that may be used in the method above include those halogenated by one or more of F, Br, Cl or I, such as one or more of F, Br or Cl, such as F.

The halogenated carbon nanomaterials may be formed by any suitable methodology. For example, the halogenated carbon nanomaterials may be formed by the steps of:
(a) sonicating a dispersion of carbon nanomaterials in water to form a carbon nanomaterial suspension; and
(b) reacting the dispersed carbon nanomaterials suspension with a solution of a hydrophilic acid to form halogenated carbon nanomaterials.

Further aspects and embodiments of the invention will now be discussed by reference to the following non-limiting examples.

### EXAMPLES

### Materials and Methods

Materials. Commercial graphene nanoplatelets (standard ISO/TS 80004-13:2017) were used in this work. Hydrofluoric acid (HF), hydrobromic acid (HBr), hydrochloric acid (HCl), polyethylene glycol octylphenyl ether (t-Oct-C₆H₄—(OCH₂CH₂)ₓOH, x=9-10), and sodium thiosulfate (Na₂S₂O₃) were purchased from Sigma-Aldrich. All materials and chemicals were used without further purification unless specifically mentioned.

### Characterisation.

Inductively coupled plasma mass spectrometry (ICP-MS)—5 mg of powder material was used for digestion by microwave, reverse aqua regia, at 180° C. for 15 min, the content of the following elements was analysed: Na, Mg, K, Ca, Fe, Ti, Cu, Al, and Si.
Elemental analysis (CHNS)—1 mg of powder material was used, V₂O₅ was added to the crucible to help with the combustion (Thermo Scientific, FlashSmart Elemental CHNS).
Thermogravimetric analysis (TGA)—10 mg of powder material in Al₂O₃ crucible was used with a heating rate of 20° C. per minute under synthetic air atmosphere (Netzsch, STA model F3).
Transmission electron microscopy (TEM)—Holey carbon film supported nickel (300 mesh) was used, the material in water suspension was drop cast over the grid (Jeol, JEM-3010).
X-ray photoelectron spectroscopy (XPS)—1 mg to 5 mg of powder material was used to evaluate the composition of the as-received and as-synthesised materials using mono Al target (Kα line), 1486.71 eV photons, 5 mA, 15 kV (75 W), step of 0.05 eV if range <15 eV and 0.1 eV if range >20 eV, dwell time between 100 and 400 ms (Kratos Analytical, Axis Ultra XPS). In order to identify and quantify the bands associated with different photo-emitted electrons, a data analysis and fitting method based on the deconvolution of the experimental C1s, S2P, and F1s signals were performed with CasaXPS software, after Shirley background subtraction, using a symmetric Pseudo-Voigt function (50% Gaussian and 50% Lorentzian) to fit all the peak signals.
Brunauer-Emmett-Teller (BET) analysis—procedure followed ISO 9277:210 “Determination of the specific surface area of solids by gas adsorption—BET method”, 300 mg of material in powder form was used (Micromeritics, model ASAP2420MP).
Electrochemical testing—Coin cells CR2032 (cathode composition of 80 wt. % active material, 10 wt. % conductive carbon, and 10 wt. % binder; celgard 2325 separator; electrolyte composition of 1M lithium bis(trifluoromethanesulfonyl)imide in 1,2-dimethoxyethane:1,2-dioxolane (1:1 v/v); and electrolyte volume of 50 uL) were tested at room temperature using Galvanostatic cycler (Neware, model BTS 4000) with a discharge cut-of voltage at 1.4V and charge termination at 2.6V.
   Preparation of Sulfured-Graphene Nanoplatelets (S-GNP) and Sulfured-Halogenated-Graphene Nanoplatelets S-h-GNP (where “h” Stands for the Halogens F, Br, or Cl as Per Indication) of the Current Invention

The preparation of sulfured-graphene nanoplatelets (S-GNP) of the current invention were performed through wet chemistry method in acid solution, where sulfur is directly nucleated on graphene. A previous step can be performed to improve the sulfur nucleation, preparing halogenated-graphene nanoplatelets (h-GNP) by chemical etching with acid, followed by the nucleophilic substitution of the halogens by sulfur (S-h-GNP).

Preparation of Halogenated-Graphene Nanoplatelets (h-GNP)

In a typical reaction, graphene nanoplatelets (GNP) were dispersed in deionised water (to form a concentration of 0.4 g L⁻¹) by sonication (37 Hz, 2 h, 23° C.). A sonication step during the processing is crucial to disperse graphene. The GNP/water suspension (1 L) was added into a hydrofluoric acid (HF), hydrochloric acid (HCl), or hydrobromic acid (HBr) solution (174 mL, 0.1 M). The mixture was stirred for 2 h and subsequently vacuum filtered (pore size 0.22 μm). The obtained powder was washed with deionised water to remove the excess acid until it reaches neutral pH. The final material (powder) was collected and dried in an oven under a temperature below 50° C. to give the halogenated-graphene nanoplatelets (denoted as “h-GNP”).

The chemical treatment of graphene with HF, HBr or HCl promotes the bonding (covalent, semi-ionic, and/or ionic) of F, Cl, or Br to C, producing Fluoro-, Chloro-, or Bromo-graphene nanoplatelets. The method to obtain halogenated-graphene proposed here is scalable and is lower in price than other techniques, e.g. chemical vapour deposition under plasma and thermal treatments in furnaces/ovens with controlled atmosphere.

### Preparation of Sulfured-Graphene (S-GNP) and Sulfured-Halogenated-Graphene Nanoplatelets (S-h-GNP) of the Current Invention

An ideal balanced reaction between sulfuric acid and sodium thiosulfate in water suspension produces equimolar amounts of sulphur. By adding a carbon-based nanomaterial (e.g. graphene) to the reaction, the carbon structure acts as a host for the sulphur produced, by chemical and physical interactions.

As an example, in a typical reaction, a non-ionic surfactant/water solution was first prepared by adding 1.2% v/v of polyethylene glycol octylphenyl ether to deionised water. Sodium thiosulfate was added to the solution to reach a concentration of 0.3M and stirred until dissolved. 0.4 g L⁻¹ of GNP or h-GNP was dispersed into the above solution by sonication (37 Hz, 2 h, 23° C.). Sulfuric acid (0.3M) was added dropwise to the suspension under stirring to reach 37.5% v/v and kept under stirring for 24 hours. The suspension was filtered (pore size 0.22 μm), and the solid material was washed with deionised water until neutral pH. The solid material was collected and dried in an oven at a temperature below 50° C. Alternative methods for washing and drying can be used; for example, washing can be performed using dialysis membranes instead of filters, and drying can be done using freeze-drying or spray drying methods.

Sulfur impregnation can happen by, but not limited to, intercalation and nucleation of sulfur atoms or sulfur oxides on graphene, according to the heterogeneous crystal growth mechanism; further, the molecules of sulfur grow on the surface, defect zones (e.g. pores), and edges of graphene or of halogenated-graphene (i.e. the edges of the carbon nanomaterial (or halogenated carbon nanomaterial)).

The sulfur nucleation in the halogenated-graphene can be improved by the presence of halogen atoms bonded mainly, but not limited to, to carbon active-sites on the graphene structure. It occurs mainly, but not limited to, to nucleophilic substitution reaction, also known as the ion-exchange reaction. In the final material, a graphene carbon structure doped with sulfur is obtained.

Characterisation of as-Received GNP and as-Synthesised S-GNP and S-h-GNP by ICP-MS, CHNS Elemental Analysis, Thermogravimetric Analysis (TGA), Brunauer-Emmett-Teller (BET) Analysis, Transmission Electron Microscopy (TEM) Imaging, and X-Ray Photoelectron Spectroscopy (XPS)

Low levels of contaminants were detected by ICP-MS (Table 1) in the as-received GNP. The acid treatments helps on purifying the graphenes removing any organic or metallic impurities (Table 1, results for F-GNP, Cl-GNP, Br-GNP, and S-GNP) that may remain from the processing or from the raw materials used to produce commercial graphenes. HF and HCl react with silica from the glass containers used during the acid treatment, so an increase in the Si content was detected on those samples. Nevertheless, the HS treatment cleans any residual contamination.

TABLE 1
Content of contaminant elements by ICP-MS in the
as-received GNP and as-synthesised materials

| | Elements (wt. %) | | | | | | | | |
|---|---|---|---|---|---|---|---|---|---|
| Sample | Na | Mg | K | Ca | Fe | Ti | Cu | Al | Si |
| GNP | 0.18 | 0.05 | 0.02 | 0.07 | 0.10 | <0.01 | <0.01 | 0.05 | 0.05 |
| F-GNP | N.D. | N.D. | N.D. | N.D. | 0.03 | N.D. | <0.01 | N.D. | 0.18 |
| Cl-GNP | <0.01 | N.D. | N.D. | N.D. | 0.03 | N.D. | N.D. | <0.01 | 0.09 |
| Br-GNP | N.D. | N.D. | N.D. | N.D. | 0.03 | N.D. | N.D. | <0.01 | 0.01 |
| S-GNP | <0.01 | N.D. | N.D. | <0.01 | <0.01 | <0.01 | N.D. | <0.01 | N.D. |

N.D.: Not Detected

To evaluate the sulfur content on the as-synthesised materials of the current invention, elemental and thermogravimetric analyses were carried out. As shown in Table 2, the elemental analysis (CHNS) presented an average sulfur content of 91.6%. This result was confirmed by the TGA analysis, which also demonstrated an average sulfur content of 91.6 wt. % (Table 3). The sulphur content detected on all halogenated graphenes are higher than the non-halogenated graphene by about ˜1.5 to 5.3 wt. %

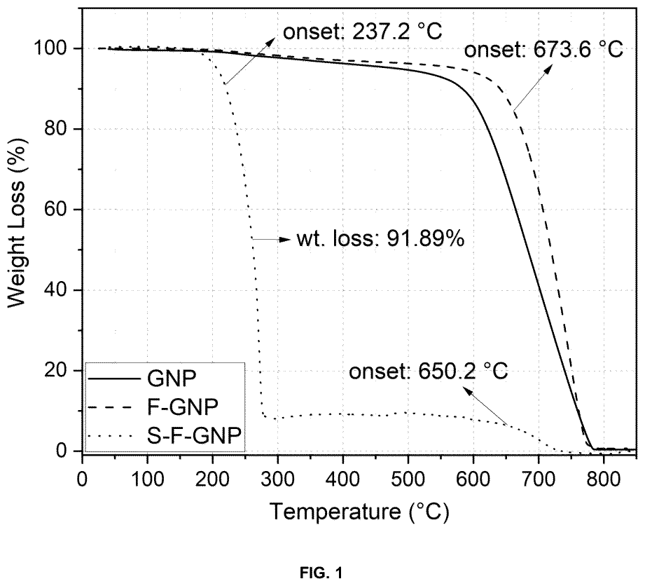

In addition, all the acid treatments increased the thermal stability (onset detected by TGA, and example for F-GNP shown in FIG. 1) of S-GNP, F-GNP, Br-BNP, and Cl-GNP to more than 70° C., 65 C, 76° C., and 72° C. in comparison to the non-acid treated GNP, respectively, as shown in Table 2.

TABLE 2
Carbon, hydrogen, nitrogen and sulfur
content by CHNS elemental analysis

| Sample | C (wt. %) | H (wt. %) | N (wt. %) | S (wt. %) |
|---|---|---|---|---|
| GNP (as received) | 95.01 | <0.50 | <0.50 | N.D. |
| F-GNP | 84.18 | <0.50 | <0.50 | N.D. |
| Cl-GNP | 90.75 | <0.50 | <0.50 | N.D. |
| Br-GNP | 95.70 | <0.50 | N.D. | N.D. |
| S-GNP | 8.93 | <0.50 | N.D. | 88.27 |
| S-F-GNP | 8.32 | <0.50 | N.D. | 91.41 |
| S-Br-GNP | 7.61 | <0.50 | N.D. | 93.25 |
| S-Cl-GNP | 7.80 | <0.50 | N.D. | 93.57 |

N.D.: Not Detected

TABLE 3
Sulfur content and graphene decomposition onset
temperature by thermogravimetric analysis

| Sample | S (wt. %)* | Graphene decomposition Tₒₙₛₑₜ (° C.) |
|---|---|---|
| GNP | 0.0 | 600.2 |
| S-GNP | 90.44 | 670.2 |
| F-GNP | 0.0 | 673.6 |
| S-F-GNP | 91.89 | 650.2 |
| Cl-GNP | 0.0 | 675.6 |
| S-Cl-GNP | 92.03 | 661.8 |
| Br-GNP | 0.0 | 673.0 |
| S-Br-GNP | 91.88 | 668.0 |

*Measured at extrapolated endset temperature (T_{endset})

As determined by BET, the surface area of S—F-GNP decreased by more than 95% in comparison with GNP and F-GNP (Table 4), which suggests that the stacked structure (interlayers) of graphene, pores, and defects were filled with sulfur. It was also observed that no significant increase in the surface area was detected after the GNP was treated with HF.

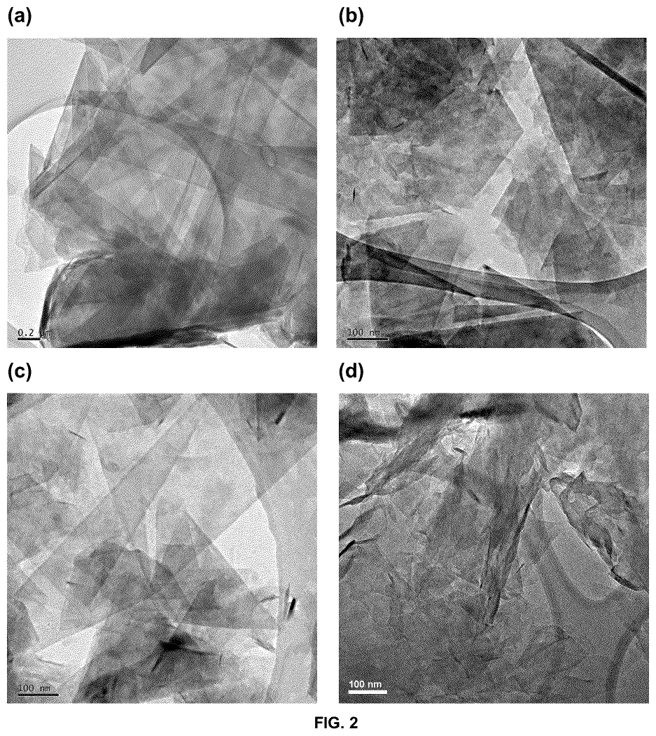

Furthermore, no increment in porosity or in defects were noticed comparing the TEM images of as-received GNP (FIG. 2a) and as-synthesised materials (vide examples for F-GNP, F-S-GNP, and S-GNP at FIG. 2b-d). This observation differs from reported studies, as the removal of attached contaminants from the basal plane of graphene by acid treatments can generate pores in the graphene structure. However, as presented above (Table 1), the commercial graphenes used in this work show low levels of contaminants. Therefore, no significant changes in the surface area or structure were observed.

TABLE 4
BET surface area of GNP, F-GNP and S-F-GNP.

| Sample | BET surface area (m² g⁻¹) |
|---|---|
| GNP | 103.4 |
| F-GNP | 104.1 |
| S-F-GNP | 4.7 |

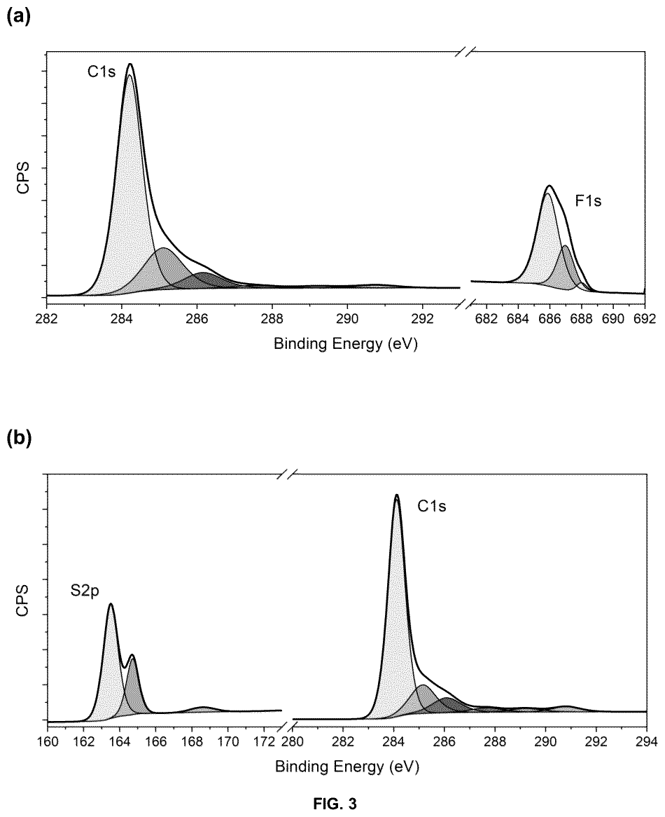

The deconvolution of the peaks obtained by XPS shows the chemical bonds present in each material as-received (GNP) and as-synthesised (Table 5), confirming the presence of halogen on F-GNP (vide example on FIG. 3a, and Table 6), Cl-GNP, and Br-GNP and sulphur on S-GNP, S—F-GNP (FIG. 3b), S—Cl-GNP, and S—Br-GNP bonded to the carbon structure of graphene (details on Table 5 and Table 6). For all samples, the graphitic carbon (C—C sp2) was found at 284.2±0.2 eV, aliphatic carbon (mainly C—C sp3) at 285.2±0.3 eV), epoxy groups (C—O—C) at 286.3±0.3 eV, carbonyl groups (C═O) at 287.4±0.3 eV, carboxyl groups (—COOH) at 288.9±0.3 eV, and plasmon/shake-up contribution (secondary peak π-π) at 290.3±0.4 eV. For the as-synthesised halogenated materials, the chemical species with halogens and carbon bonds were found mixed with the signals from GNP. For the material F-GNP, the signals from C—C and C-F_{ionic} groups were found mixed at 285.3±0.2 eV, C═O and C-F_{semi-ionic} at 287.8±0.3 eV, and pi-pi and C—F_{covalent} at 290.7±0.4 eV; for Cl-GNP material, the signals from C—O and C—Cl were found at 286.6±0.4 eV; and for Br-GNP, the signals from C—O and C—Br were found at 286.2±0.3 eV.

At the S2p region (details on Table 6), two peaks centered at 163.7±0.2 eV and 164.9±0.2 eV were fitted and assigned to S2p3/2 and S2p1/2, respectively. The S2p3/2 and S2p1/2 bonding configurations can be attributed to the formation of C═S and C—S bonds in the structure of GNP. Another peak at 168.8±0.2 eV related to sulfur oxide species (—C—SOₓ—C— bonding) was detected.

TABLE 5
XPS results from peaks deconvolution at C1s region

| Sample | Chemical Bond | Position (eV) | Area (%) |
|---|---|---|---|
| GNP | C═C | 284.21 | 74.74 |
| | C—C | 285.28 | 7.47 |
| | C—O | 286.00 | 7.39 |
| | C═O | 287.70 | 3.81 |
| | —COOH | 289.38 | 3.04 |
| | π-π | 291.07 | 3.55 |
| F-GNP | C═C | 284.20 | 68.57 |
| | C—C/C—F_{ionic} | 285.10 | 20.01 |
| | C—O | 286.21 | 7.50 |
| | C═O/C—F_{semi-ionic} | 287.78 | 1.36 |
| | —COOH | 289.2 | 1.07 |
| | π-π/C—F_{covalent} | 290.50 | 1.50 |
| Cl-GNP | C═C | 284.21 | 71.77 |
| | C—C | 284.90 | 23.31 |
| | C—O/C—Cl | 286.41 | 3.12 |
| | C═O | 288.10 | 0.37 |
| | —COOH | 289.2 | 0.91 |
| | π-π | 290.50 | 0.52 |
| Br-GNP | C═C | 284.19 | 72.90 |
| | C—C | 285.06 | 16.48 |
| | C—O/C—Br | 286.23 | 4.60 |
| | C═O | 288.10 | 1.24 |
| | —COOH | 289.2 | 2.47 |
| | π-π | 290.50 | 2.29 |
| S-GNP | C═C | 284.11 | 72.46 |
| | C—C | 285.04 | 13.50 |
| | C—O/C—S | 286.01 | 9.17 |
| | C═O | 287.72 | 1.81 |
| | —COOH | 289.24 | 1.30 |
| | π-π | 290.71 | 1.75 |
| S-Br-GNP | C═C | 284.06 | 72.96 |
| | C—C | 285.01 | 15.40 |
| | C—O/C—S | 286.00 | 8.06 |
| | C═O | 287.70 | 1.54 |
| | —COOH | 289.12 | 0.71 |
| | π-π | 290.46 | 1.34 |
| S-Cl-GNP | C═C | 284.06 | 70.35 |
| | C—C | 284.90 | 18.01 |
| | C—O/C—S | 286.00 | 7.86 |
| | C═O | 287.70 | 1.59 |
| | —COOH | 289.39 | 1.00 |
| | π-π | 290.75 | 1.18 |
| S-F-GNP | C═C | 284.11 | 70.62 |
| | C—C | 285.15 | 13.93 |
| | C—O/C—S | 286.08 | 7.98 |
| | C═O | 287.70 | 2.55 |
| | —COOH | 289.21 | 2.08 |
| | π-π | 290.81 | 2.84 |

TABLE 6
XPS results from peaks deconvolution (area %) at S2p region

| | Sample | | | |
|---|---|---|---|---|
| Chemical Bond | S-GNP | S-F-GNP | S-Cl-GNP | S-Br-GNP |
| C—S—C/S2p3/2 | 62.84 | 67.88 | 67.53 | 54.60 |
| C═S/S2p1/2 | 30.64 | 27.35 | 32.47 | 26.27 |
| —C—SOx—C— | 6.52 | 4.77 | N.D. | 19.13 |

Performance of Sulfur batteries

The S-GNP and S-h-GNPs of the current invention can be used as both cathode and anode active materials for different electrochemical energy storage devices, e.g. as cathode against any active anode material which has an electrochemical redox potential below 1.4 V versus Li (for example, Si, Li, Na, Mg, Al, Ca, and graphite); and as an anode against any active cathode material which has an electrochemical redox potential above 2.6 V versus Li (for example, LiMn₂O₄ and LiCoO₂); in both scenarios, as cathode or anode, the batteries can use organic, ionic, aqueous-based, quasi-solid, or solid electrolytes.

As an example, we demonstrate the performance of S-GNP and S-h-GNPs as the active material in the cathode against Li metal as the anode. The Li metal acts as the counter and the reference electrode. The configuration of the cells was kept as standard as possible to compare the as-synthesised materials' performance with the technical literature, that means the cells were not optimised or configured to improve the capacity, rate capability, cycle life, etc., which also depends on many factors such as the composition of the cathode, composition of the electrolyte, additives, electrolyte/sulphur ratio, interlayers, etc.

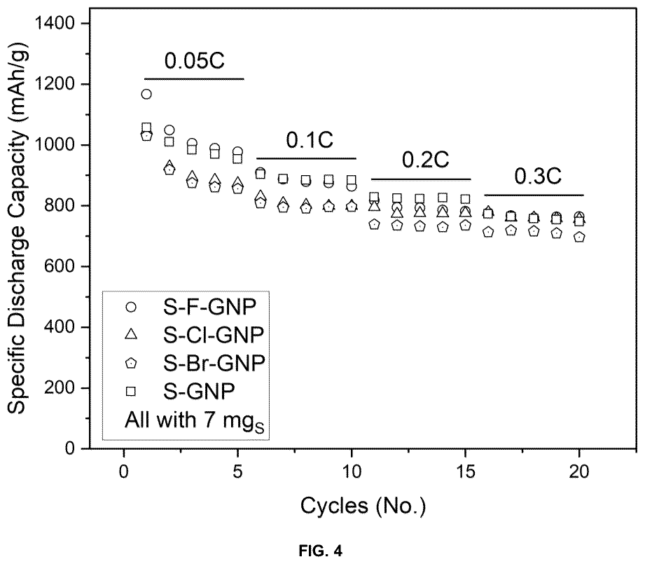

FIG. 4 presents the specific discharge capacity under different current rates. S—F-GNP present the higher first discharge capacity of 1,167 mAh gₛ⁻¹ at 0.05 C. S-Cl-GNP, S-Br-GNP, S-GNP have similar first discharge capacity of ˜1,045 mAh gₛ⁻¹ at 0.05 C. S—F-GNP and S-GNP present higher capacities over the evaluated different rates (˜886 mAh gₛ⁻¹ at 0.1 C, ˜809 mAh gₛ⁻¹ at 0.2 C, and ˜762 mAh gₛ⁻¹ at 0.3 C) in comparison to S-Cl-GNP and S-Br-GNP which presented lower capacities (˜802 mAh gₛ⁻¹ at 0.1 C, ˜756 mAh gₛ⁻¹ at 0.2 C, and ˜736 mAh gₛ⁻¹ at 0.3 C).

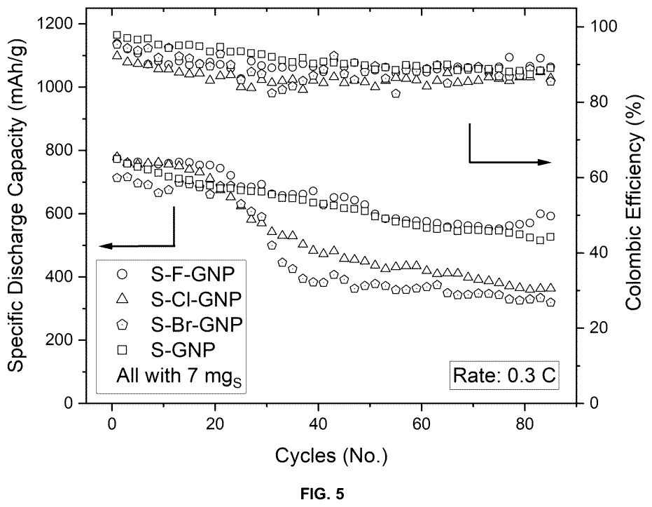

FIG. 5 presents the specific discharge capacity and Coulombic efficiency over 85 cycles at 0.3 C. S—F-GNP, S-Cl-GNP, and S-GNP displayed an initial capacity of over 770 mAh gₛ⁻¹ after the current rate study (FIG. 4), while S-Br-GNP presented a lower capacity of 712 mAh gₛ⁻¹. Among all the materials synthesised S—F-GNP presented the highest capacity retention of 76% over the 85 cycles, followed by S-GNP with 68%. S-Cl-GNP and S-Br-GNP shown capacity retention lower than 47%. The average Coulombic efficiency of the as-synthesised materials is above 89.5%±3.

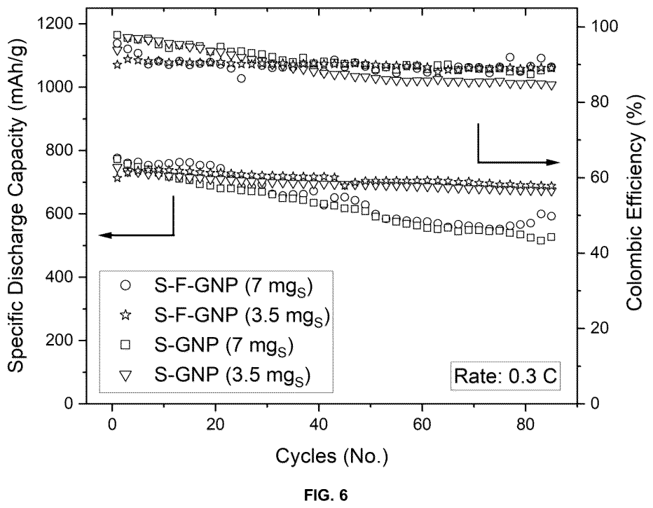

S—F-GNP and S-GNP presented an overall best electrochemical performance among all the as-synthesised materials. Therefore, further studies were conducted with different active material mass loadings for these materials. FIG. 6 presents the cycling stability of S—F-GNP and S-GNP with sulphur mass loadings of 7 mg and 3.5 mg at 0.3 C.

Independent on the halogenation or on the mass loading the materials provided comparable initial capacities and Coulombic efficiencies (FIG. 6), with an average capacity of 757 mAh gₛ⁻¹, and an average Columbic efficiency of 88%±2.25, after current rate study. At the end of 85 cycles, S—F-GNP and S-GNP with 7 mgs shows a capacity retention of 76% and 68% respectively, while the S—F-GNP and S-GNP with 3.5 mgs shows a capacity retention of 97% and 90% respectively.

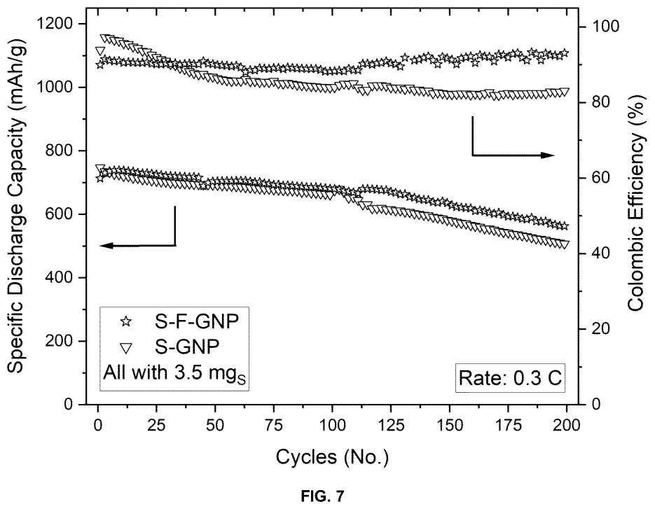

FIG. 7 presents the cycling stability of S—F-GNP and S-GNP with sulphur mass loading of 3.5 mg at 0.3 C for 200 cycles. S—F-GNP and S-GNP shows an specific discharge capacity of 713.3 mAh gₛ⁻¹ and 742.2 mAh gₛ¹ after the current rate study (not shown), respectively, and a capacity retention of 78.9% and 67.9% respectively after 200 cycles. The average Coulombic efficiency of S—F-GNP and S-GNP over 200 cycles is 90.7% and 85.7% respectively.

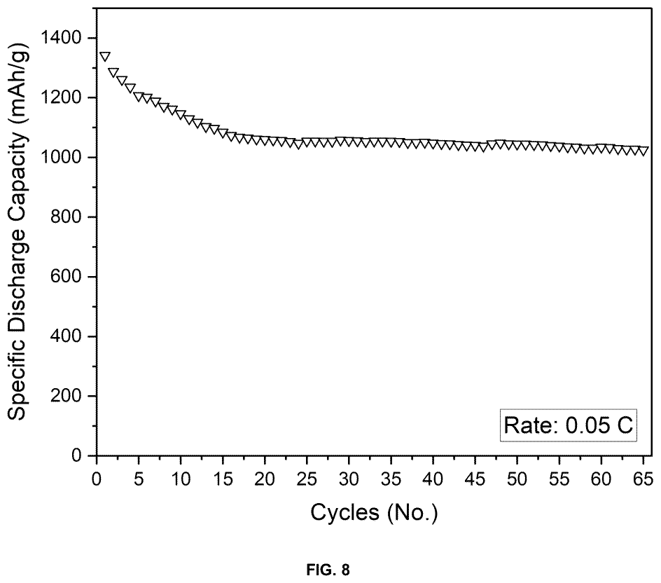

FIG. 8 presents the specific discharge capacity for the as-synthesised S-GNP with sulphur loading of 3.5 mg at 0.05 C rate for 50 cycles. At these condictions S-GNP gave an first specific discharge capacity of 1,341 mAh gₛ⁻¹, after the 15^{th} cycle the cell reached stability and delivered specific discharge capacity of 1085 mAh gₛ⁻¹ with capacity retention of 94.5% after 50 cycles.

1. A nanoparticulate material, comprising:
a carbon nanomaterial having a plurality of active sites; and
sulfur attached to the plurality of active sites of the carbon nanomaterial, wherein the sulfur forms from 50 wt. % to 99 wt. % of the composition when measured using one or both of CHNS elemental analysis and thermogravimetric analysis.

2. The nanoparticulate material according to claim 1, wherein the carbon nanomaterial is selected from one or more of the group consisting of carbon nanotubes, carbon nanofibers, fullerenes, graphenes, graphene oxides, nanographites, carbon blacks, acetylene blacks, thermal blacks, mesoporous carbons, carbon quantum dots, and graphene quantum dots.

3. The nanoparticulate material according to claim 2, wherein the carbon nanomaterial is one or both of a graphene and a carbon black

4. The nanoparticulate material according to claim 3, wherein the graphene is in the form of graphene nanoplatelets and the carbon black is in the form of Ketjen black.

5. The nanoparticulate material according to claim 1, wherein the nanoparticulate material may further comprise halogen atoms bonded to the carbon nanomaterial.

6. The nanoparticulate material according to claim 1, wherein the nanoparticulate material further comprises halogen atoms attached to a first portion of the plurality of active sites.

7. The nanoparticulate material according to claim 5, wherein the halogen atoms are selected from one or more of the group consisting of F, Cl, Br, and I.

8. The nanoparticulate material according to claim 1, wherein the sulfur forms from 50 to 97 wt. % of the composition when measured using one or both of CHNS elemental analysis or thermogravimetric analysis.

9. The nanoparticulate material according to claim 8, wherein the sulfur content is from 70 to 96 wt % of the composition when measured using one or both of CHNS elemental analysis or thermogravimetric analysis.

10. The nanoparticulate material according to claim 9, wherein the sulfur content is from 85 to 95 wt % of the composition when measured using one or both of CHNS elemental analysis or thermogravimetric analysis.

11. The nanoparticulate material according to claim 1, wherein at least part of the sulfur is covalently bonded to a second portion of the plurality of active sites of the carbon nanomaterial.

12. The nanoparticulate material according to claim 1, wherein
the plurality of active sites are one or more active sites selected from the group consisting of a surface, an edge, a defect, and an interlayer.

13. The nanoparticulate material according to claim 1, wherein a first portion of the sulfur is electrostatically bonded (ionically/Van der Waals) to the carbon nanomaterial and a second portion of the sulfur is covalently bonded.

14. A sulfur battery comprising:
a cathode comprising a nanoparticulate material as described in claim 1;
an anode;
an electrolyte; and
a separator.

15. The metal sulfur battery according to claim 14, wherein the metal sulfur battery is selected from one or more of the group consisting of Si, Li, Na, Mg, Al, Ca, graphite.

16. A sulfur battery comprising:
an anode comprising a nanoparticulate material as described in claim 1;
a cathode;
an electrolyte; and
a separator.

17. The sulfur battery according to claim 16, wherein the sulfur cathode is selected from one or more of the group selected from LiMn₂O₄, LiNiMn₂O₄, LiNiMnCoO₂, LiCoO₂ and LiFePO₄.

18. The sulfur battery according to claim 14, wherein a specific energy density of the metal-sulfur battery is from 600 Wh to 3,600 Wh per kilogram of sulphur, with a total sulfur mass loading of from 1 to 30 mg cm⁻².

19. The sulfur battery according to claim 18, wherein the specific energy density of the sulfur battery is from 2,210 Wh to 2,883 Wh per kilogram of sulfur at a current rate of 0.05 C with a sulfur mass loading of from 3.5 to 7 mg over an electrode area of 2 cm².

20. A method of making a nanoparticulate material according to claim 1, wherein the method comprises the steps of:
(a) providing carbon nanomaterials and dispersing them into a solution comprising water, a non-ionic surfactant and a metal thiosulfate to form a precursor solution; and
(b) adding an aqueous sulfuric acid solution to the precursor solution and allowing reaction for a period of time to form the nanoparticulate material.

21.-24. (canceled)
